(19) United States
(12) Patent Application Publication
(10) Pub. No.: US 2024/0391256 A1
(43) Pub. Date: Nov. 28, 2024

(54) DRYING DEVICE

(71) Applicant: CANON KABUSHIKI KAISHA, Tokyo (JP)

(72) Inventors: JUN KAWAKITA, Chiba (JP); HIROSHI KOKUBO, Tokyo (JP); YOSHIAKI HARA, Chiba (JP); KOHEI AOKI, Chiba (JP); YUSHI SADAMITSU, Tokyo (JP)

(21) Appl. No.: 18/637,724

(22) Filed: Apr. 17, 2024

(30) Foreign Application Priority Data
May 24, 2023 (JP) 2023-085248
Oct. 5, 2023 (JP) 2023-173857

(51) Int. Cl. B41J 11/00

(52) U.S. Cl. CPC B41J 11/0022

(57) ABSTRACT

A drying device for drying a sheet on which an image is formed by discharged ink includes a conveyance portion, a fan; a duct guiding an air blown from the fan to the conveyed sheet and a heater heating the air in the duct. The duct includes a plurality of nozzles blowing the air in the duct to the conveyed sheet, a first surface provided with the plurality of nozzles; a second surface opposing the first surface; and a recess portion formed along a conveyance direction of the sheet. In a widthwise direction, the recess portion is provided between a first nozzle and a second nozzle, of the plurality of nozzles, and the second nozzle is disposed side by side with the first nozzle.

### FIELD OF THE INVENTION AND DESCRIPTION OF RELATED ART

The present invention relates to a drying device dries a sheet conveyed by a belt.

Conventionally, an inkjet recording apparatus configured to form an image on a sheet by discharging an ink from an ink head is provided with a drying device to dry the sheet (referred as Japanese Laid-Open Patent Application No. 2013-86458). According to the drying device described in the JP patent application No. 2013-86458, the drying device dries the sheet by that a lot of nozzles formed in a blowing duct blow air supplied from such as a blowing fan onto the sheet conveyed by a rotating conveying belt.

Now, the nozzles are preferred to be close to the conveying belt as obtaining a gap for the sheet passing through to improve efficiency of drying the sheet. Also, the air from the nozzles must be blown harder to improve efficiency of drying the sheet. However, when the air is blown harder, the sheet is easily floated from the conveyer belt because the speed of the air that flaws in a gap is raised up. When the sheet floats from the conveying belt, the sheet may change its shape during conveying or conveying malfunction may occur.

The present invention is developed in the situation described above and an object is to provide the drying device which improves efficiency of drying a sheet and to be able to suppress the sheet floating from the conveying belt as well when the sheet is conveyed by the conveying belt and dried by the air blown.

### SUMMARY OF THE INVENTION

To solve the problem as described above, the present invention provides as follows: a drying device for drying a sheet on which an image is formed by discharged ink, the drying device comprising: a conveyance means configured to convey the sheet; a blowing fan; a duct configured to guide an air blown from a blowing fan to the sheet conveyed by the conveyance means; and a heating means configured to heat the air in the duct, wherein the duct includes: a plurality of nozzles configured to blow the air in the duct to the sheet conveyed by the conveyance means; a first surface provided with the plurality of nozzles; a second surface opposing the first surface; and at least one recess portion formed along a conveyance direction of the sheet, wherein in a widthwise direction perpendicular to the conveyance direction, the recess portion is provided between a first nozzle and a second nozzle of the plurality of nozzles, the second nozzle being disposed side by side with the first nozzle.

Further features of the present invention will become apparent from the following description of exemplary embodiments with reference to the attached drawings.

### BRIEF DESCRIPTION OF THE DRAWINGS

FIG. 1 is a schematic view of a suitable inkjet recording apparatus with a drying device of a present exemplary embodiment.

FIG. 2 is a schematic view of a print module, a drying module, and a fixing module.

FIG. 3 is a cross-sectional view showing a blowing unit.

FIG. 4 is a perspective view showing a bottom surface of an opposing duct portion in an embodiment 1.

FIG. 5 is a perspective view showing a top surface of the opposing duct portion in the embodiment 1.

FIG. 6 is a schematic view of an air flow if there are not any penetrating portions to compare.

FIG. 7 is a graph showing relation between an air speed rate and a rate between a total sum of an area size of opening portions in a penetrating portion and a total sum of an area size of holes in nozzles with warm air blowing.

FIG. 8 is a schematic view showing the penetrating portion from inside of the duct.

FIG. 9 is a bottom side view showing another form of warm air blowing nozzles.

FIG. 10 is a bottom side view showing yet another form of warm air blowing nozzles.

FIG. 11 is a perspective view showing an opposing duct portion in an embodiment 2.

FIG. 12 is a perspective view of an opposing duct portion seen from a side of top surface in an embodiment 3.

FIG. 13 is a bottom side view of the opposing duct portion seen from a side of bottom surface in the embodiment 3.

FIG. 14 is a perspective view of an opposing duct portion seen from a side of top surface in an embodiment 4.

FIG. 15 is a bottom side view of the opposing duct portion seen from a side of bottom surface in the embodiment 4.

FIG. 16 is a perspective view of an opposing duct portion seen from a side of bottom surface in an embodiment 5.

FIG. 17 is a bottom side view of the opposing duct portion seen from a side of bottom surface in the embodiment 5.

FIG. 18 is a perspective view of the opposing duct portion seen from a side of top surface in the embodiment 5.

### DESCRIPTION OF THE EMBODIMENTS

### Embodiment 1

### <Inkjet Recording Apparatus>

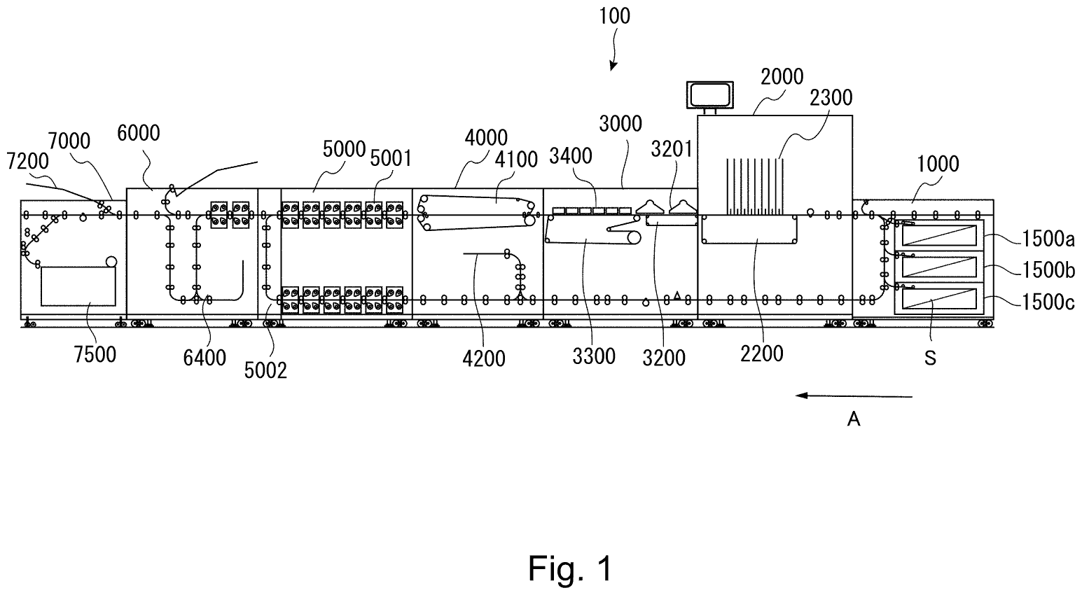

Hereinafter, embodiments of the present invention will be described with referring to Figures. First, a preferred inkjet recording apparatus implementing a drying device in a present embodiment will be described as referring to FIG. 1. An inkjet recording apparatus 100 is a so-called sheet feeding type inkjet recording apparatus which forms an image on a sheet with ink. The sheet may be a recording material that is able to accept ink, for example, a normal paper, a thick paper, a plastic film such as a sheet for an overhead projector, specific shaped sheet such as an envelope or an index card, or a cloth.

As FIG. 1 showing, the inkjet recording apparatus 100 is provided with a sheet feeding module 1000, a printing module 2000, a drying module 3000, a fixing module 4000, a cooling module 5000, a reversing module 6000, and a stacking module 7000. A sheet S fed from the sheet feeding module 1000 goes through each process in each module while the sheet is conveyed along with a conveying passage and is discharged onto the stacking module 7000 lastly.

Note that, the sheet feeding module 1000, the printing module 2000, the drying module 3000, the fixing module 4000, the cooling module 5000, the reversing module 6000, and the stacking module 7000 may include each casing and connect to comprise the inkjet recording apparatus. Also, the sheet feeding module 1000, the printing module 2000, the drying module 3000, the fixing module 4000, the cooling module 5000, the reversing module 6000, and the stacking module 7000 may be located inside of one casing of the inkjet recording apparatus.

The sheet feeding module 1000 includes sheet storages 1500a, 1500b, and 1500c. The sheet storages 1500a to 1500c is provided as being able to draw toward a front side where it is installed to accommodate the sheet S. The sheet S is fed one sheet at a time by a separating belt and a conveying roller in each sheet storage 1500a to 1500c and is conveyed to the printing module 2000. Note that, the sheet storages 1500a to 1500c are not limited to three storages, but may be one storage, two storages, or even four storages or more.

The printing module 2000 includes a pre-image forming registration adjusting portion (not shown), a printing belt unit 2200, and a recording portion 2300. The sheet S conveyed from the sheet feeding module 1000 is adjusted incline and position of the sheet by the pre-image-forming registration adjusting portion and conveyed to the printing belt unit 2200.

The recording portion 2300 is located in a position where is facing the printing belt unit 2200 with respect to the conveying passage of the sheet S. The recording portion 2300 forms an image onto the sheet S with ink discharged by a plurality of recording heads from above with respect to the sheet S conveyed. The sheet S is ensured clearance from a recording head because the sheet S is suctioned and conveyed by the printing belt unit 2200. Five in total of a line type recording heads corresponding to four ink colors of Y (yellow), M (magenta), C (cyan), Bk (black) and reaction liquid are aligned along with a conveying direction (an arrow A) in the present embodiment.

Note that, a number of the ink colors or the recording head is not limited to five. Also, for an inkjet type that discharges ink, for example, a heating element type, a piezoelectric element type, an electrostatic element type, or a MEMS (micro electro mechanical systems) element type are able to be adopted. The inks of each color are supplied from ink tanks (not shown) of each color to the recording heads through ink tubes.

In a downstream side of a conveying direction of the recording portion 2300, an in-line scanner (not shown) is provided. The sheet S on which an image is formed is conveyed to the in-line scanner by the printing belt unit 2200 and the in-line scanner (not shown) detects a formed image on the sheet S. Based on the formed image on the sheet S, misalignment or color density of the image forming on the sheet S is configured to adjust.

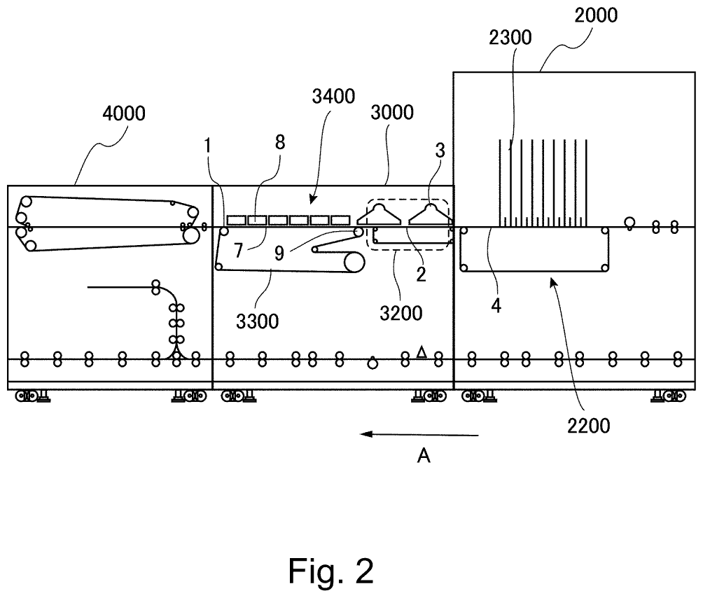

The drying module 3000 includes a decoupling portion 3200, a drying belt unit 3300, and a warm air blowing unit 3400. The drying module 3000 reduces a liquidity amount of ink applied to the sheet S to improve fixing performance of the fixing module 4000 following by. The sheet S that is formed an image is conveyed to the decoupling portion 3200 in the drying module 3000. In the decoupling portion 3200, air pressure which is blown from above by a blowing unit 3201 generates friction between the sheet S and a decoupling belt 2 (refer in FIG. 2) and the sheet S is conveyed by the decoupling belt 2. Thus, it is configured to prevent the sheet S which is placed on the decoupling belt from misalignment by conveying with friction while the sheet S is conveyed through a print unit 2010 and the decoupling portion 3200.

The sheet S which is conveyed from the decoupling portion 3200 is suctioned and conveyed by the conveying belt 7 (referred in FIG. 2) in the drying belt unit 3300, and then, is blown by warm air from the warm air blowing unit 3400 provided above the conveying belt 7. Thus, by drying an image formed surface of the sheet S on which the image is formed with ink, the ink which is applied on the sheet S is heated and accelerated to evaporate. The drying module 3000 which dries the sheet S will be described more detail below.

The fixing module 4000 includes a fixing belt unit 4100. The fixing belt unit 4100 fixes ink onto the sheet S which is conveyed from the drying module 3000 by passing through between a heated upper belt unit and a lower belt unit.

The cooling module 5000 includes a plurality of cooling portions 5001 and the cooling portion 5001 cools down the warm sheet S conveyed from the fixing module 4000. The cooling portion 5001 cools down the sheet S by taking outside air into a cooling box with a fan to increase air pressure inside the cooling box and then blowing air onto the sheet S from the cooling box through a nozzle by pressure, for example. The cooling portions 5001 are provided on both sides with respect to the conveying passage of the sheet S and cool down both sides of the sheet S.

The cooling module 5000 includes a conveying passage switching portion 5002. The conveying passage switching portion 5002 switches the conveying passage of the sheet S corresponding to a case which the sheet S is conveyed to the reverse module 6000 or a case which the sheet S is conveyed to a double-side conveying passage for double-side printing which the image is formed on both sides of the sheet S.

The reversing module 6000 includes a reverse portion 6400. The reversing portion 6400 reverses a front and a back side of the sheet S conveyed to change a side of the sheet S when the sheet S is discharged onto the stacking module 7000. The stacking module 7000, which includes a top tray 7200 and a stacking portion 7500, stacks the sheet S conveyed from the reversing module 6000.

During the double-side printing, the sheet S is conveyed onto the conveying passage which is located below the cooling module 5000 by the conveying passage switching portion 5002. Later, the sheet S is brought back to the printing module 2000 after passing through the double-side conveying passage of the fixing module 4000, the drying module 3000, the printing module 2000, and the sheet feeding module 1000. A double-side conveying portion of the fixing module 4000 is provided with a reversing portion 4200 which reverses the front and the back side of the sheet S. The sheet S which is brought back to the printing module 2000 is formed an image with ink on another side which an image has not been formed yet and is proceeded through the drying module 3000, the fixing module 4000, the cooling module 5000, and the reversing module 6000 and is discharged onto the stacking module 7000.

### <Drying Module>

Next, the drying module will be described with FIG. 2. As FIG. 2 showing, the drying module 3000 as a drying device receives the sheet S discharged from the printing module 2000 and dries the sheet S and sends the sheet S to the fixing module 4000. In the drying module 3000, the decoupling portion 3200 is provided in an upstream with respect to a conveying direction A and the drying belt unit 3300 and the warm air blowing unit are provided in downstream of the decoupling portion 3200.

The decoupling portion 3200 includes a decoupling belt 2 and a cold air blowing unit 3. By the cold air blowing unit 3 blowing cold air from above the decoupling belt 2, the sheet S is pressed onto the decoupling belt 2 that rotates, and conveyed. A lot of through holes are formed on the decoupling belt 2 to send the cold air, which is blown from the cold air blowing unit 3, from an outer peripheral surface (a front surface) through an inner peripheral surface (a back side).

Even when the leading end of the sheet S which is conveyed to a printing belt 4 in the printing belt unit 2200 reaches the decoupling belt 2, the trailing end of the sheet S is on the printing belt 4. Since the recording portion 2300 forms an image onto the sheet S being on the printing belt 4, the sheet S is suctioned and conveyed by the printing belt 4. A force which the sheet S is pressed onto the decoupling belt 2 is weaker than a force the sheet is suctioned to the printing belt 4 and the decoupling belt 2 is rotated slightly faster than the printing belt 4 in order not to cause any disturbances during an image forming process. In other words, when the trailing end of the sheet S is on the printing belt 4, the sheet S is conveyed as sliding on the decoupling belt 2.

After the trailing end of the sheet S passed the printing belt 4, conveying the sheet S depends on the decoupling belt 2. Then, a blowing force of the cold air blowing unit 3 is needed to be controlled as the sheet S dose not slide on the decoupling belt 2. Therefore, the blowing force of the cold air blowing unit 3 is adjusted by controlling the blowing fan (not shown) based on a detected result with a pressure sensor (not shown) which is provided in the cold air blowing unit 3.

The cold air blowing unit 3 includes a duct, wherein a lot of cold air blowing nozzles (not shown) to blow cold air are formed on an opposing surface that faces the printing belt 4. The cold air blowing nozzles are projecting from the opposing surface of the duct toward the printing belt 4.

The drying belt unit 3300 suctions and conveys the sheet S with a conveying belt 7 that rotates. In order that the sheet S is suctioned onto the conveying belt 7, a lot of suction holes are formed on the conveying belt 7 as air blows from an outer peripheral surface (a front side) to an inner peripheral surface (a back side) corresponding to suctioning by a suctioning fan (not shown) that is provided inside of the conveying belt 7. A suction force on the surface of the conveying belt 7 is adjusted by controlling the suctioning fan (not shown) based on a detected result with a pressure sensor (not shown) which is provided in the drying belt unit 3300. Note that, in terms of a conveying direction of the sheet S, a distance from a position where the printing belt 4 stops suctioning to a position where the conveying belt 7 starts suctioning is determined as longer than a maximum sheet length of the sheet S which is able to be formed an image on.

Further, the conveying belt 7 is heated by a heater roller 9 which includes a halogen heater (not shown) inside. For drying the sheet S quickly, temperature of the surface of the conveying belt 7 is adjusted by temperature of the halogen heater controlled corresponding to a detected result of a temperature sensor which is provided in the drying belt unit 3300.

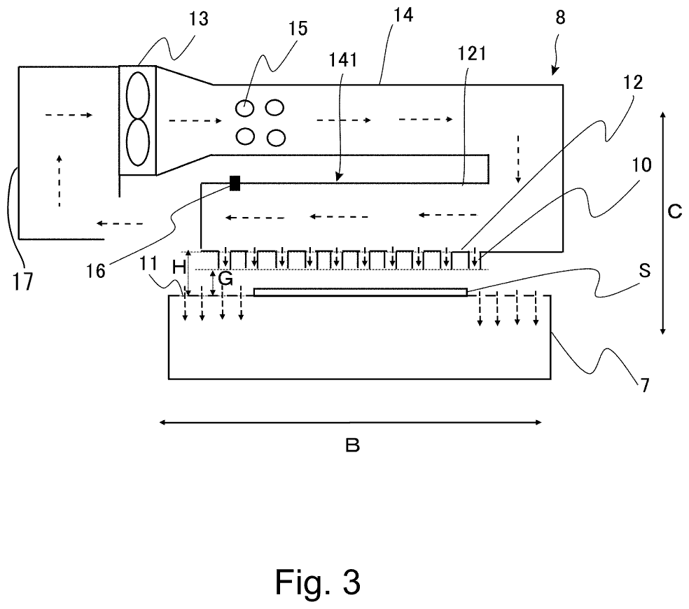

The warm air blowing unit 3400 includes a plurality of blowing unit 8 aligned in the conveying direction of the sheet S. The blowing unit 8 blows warm air from above onto the sheet S conveyed by the conveying belt 7 and dries the sheet S. In blowing unit 8 a sheath heater 15 as a heating means heats air and generates warm air. The temperature of the warm air is adjusted to a predetermined temperature by that the sheath heater is controlled corresponding to a detected result with a temperature sensor 16 (refer in FIG. 3) which is provided in the blowing unit 8.

As described below, the blowing unit 8 includes a blowing duct on which a lot of warm air blowing nozzles are formed on an opposing surface (bottom side) that faces to the conveying belt 7 to blow warm air onto the sheet S. A blowing speed of warm air blown from the warm blowing nozzles onto the sheet S is adjusted to a predetermined by that a blowing fan 13 (refer in FIG. 3) is controlled to blow corresponding to a detected result with a blowing speed sensor (not shown) provided in the blowing unit 8.

### <Blowing Unit>

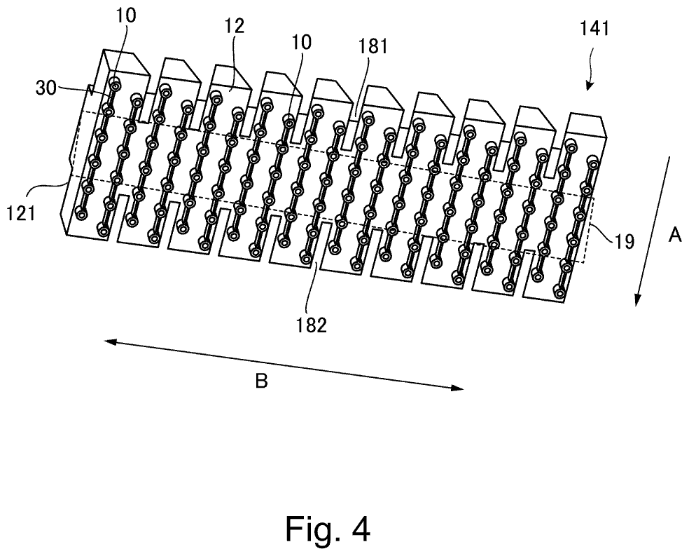

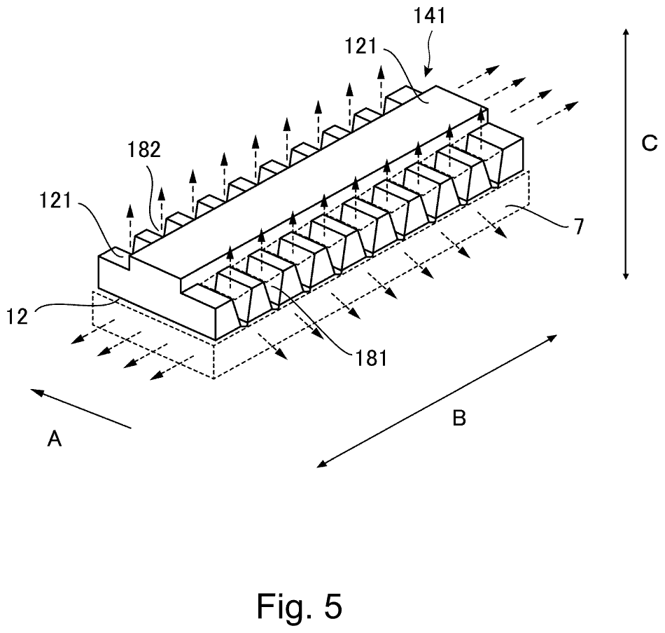

Next, the blowing unit 8 will be described with as referring FIG. 3 to FIG. 5. FIG. 3 is a cross-sectional view of the blowing unit 8. FIG. 4 is a perspective view of the bottom side of the blowing duct. FIG. 5 is a perspective view of the top side of the blowing duct. Note that, arrows with dotted lines in FIG. 3 and FIG. 5 indicate a direction of air flow.

As FIG. 3 showing, the blowing unit 8 includes the blowing fan 13, a blowing duct 14, the sheath heater 15, the temperature sensor 16, and a suction duct 17. The suction duct 17 is connected with a suction side of the suction fan (not shown) and the blowing fan 13. The blowing fan 13 is a fan such as an axial fan and is connected to the blowing side of the blowing fan 13 and the blowing duct 14. The sheath heater 15 and the temperature sensor 16 is provided in the blowing duct 14. The sheath heater 15 is located in a downstream of a blowing passage of the blowing fan 13 is configured to generate warm air by heating air sent from the blowing fan 13. The temperature sensor 16 is provided to control the sheath heater 15 in order to adjust the warm air temperature to a predetermined temperature as described above. The blowing duct 14 sends air (warm air), which is sent from the blowing fan 13 and heated by sheath heater 15, to a position where faces the sheet S that is conveyed by the conveying belt 7. Note that, the blowing fan 13 may be other kind of air source, such as a sirocco fan, and the sheath heater may be other kind of heating source, such as a kanthal heater.

In the present embodiment, the blowing duct 14 includes an opposing duct portion 141 which faces the conveying belt 7. On a warm air blowing surface 12, which is an opposing surface faces the conveying belt 7 of the opposing duct portion 141, a plurality of warm air blowing nozzles 10, which blow warm air sent in the opposing duct portion 141 onto the sheet S that conveyed by the conveying belt 7, are projecting toward the conveying belt 7.

### <Warm Air Blowing Nozzles>

Each of the warm air blowing nozzles 10 is formed as cylindrical shape of which cross-section is circular and a length between the warm air blowing surface 12 and an end of the nozzle is set to, for example, “5 mm”. Then, the blowing unit 8 is located with respect to the conveying belt 7 as a distance G, which is a length between the ends of the warm air blowing nozzles 10 and the conveying belt 7, is “10 mm”, in other words, as a distance H, which is a length between the warm air blowing surface 12 and the conveying belt 7, is “15 mm”. Thus, by that the warm air blowing nozzles 10 are provided on the warm air blowing surface 12, the warm air blowing nozzles 10 are able to blow warm air onto the sheet S from closer position as the warm air blowing surface 12 keeps the distance from the conveying belt 7 to increase drying efficiency by blowing warm air. For example, when the conveying speed of the sheet S conveyed by the conveying belt 7 is “700 mm/s”, the blowing speed of warm air blown from the warm air blowing nozzles 10 is set as “about 33 m/s”.

Blowing holes to blow warm air from inside of the opposing duct portion 141 are formed on the end of the warm air blowing nozzles 10. As FIG. 4 showing, the warm air blowing nozzles 10 are evenly provided in a conveying direction A of the sheet S and a width direction B which crosses the conveying direction A of the sheet S as an area of the blowing holes per unit area is uniform on the warm air blowing surface 12. For example, a diameter of the blowing hole is “2 mm”, a space between each blowing hole in the conveying direction A is “14 mm” and a space between each blowing hole in the width direction B is “14 mm”. Further, the warm air blowing nozzles 10 are provided as adjacent rows in the width direction B and each blowing holes of the warm air blowing nozzles 10 on those rows are offset by “7 mm” in the conveying direction A. Also, in terms of the width direction B, the warm air blowing nozzles 10 are provided as covering wider area than the widest width size of the sheet S to blow warm air on a wider area than the maximum size of the area of the sheet S on which an image can be formed.

In the present embodiment, as FIG. 3 showing, when the blowing fan 13 drives, air which is suctioned by the blowing fan 13 through the suction duct 17 reaches the sheath heater 15 in the blowing duct 14. The (warmed) air, which is heated in the sheath heater 15, goes through the warm air blowing nozzles 10 and is blown onto the sheet S conveyed by the conveying belt 7. Note that, the temperature sensor 16 is located on a top side 121 which is opposite to the warm air blowing surface 12 with respect to a direction (referred as an arrow C) which crosses to the warm air blowing surface 12 of the opposing duct portion 141.

### <Penetrating Portion>

Also, as FIG. 4 and FIG. 5 showing, the blowing duct 14 includes a plurality of penetrating portions 181 and 182 penetrates from the warm air blowing surface 12 toward the top side 121 in a direction perpendicular to the warm air blowing surface 12 in the opposing duct portion 141 and are not communicated to inside of the opposing duct portion 141. The penetrating portions 181 and 182 are formed on both ends of the opposing duct portion 141 with respect to the conveying direction A and formed as an elongated shape that the length of the conveying direction A is longer than the length of the width direction B.

The penetrating portion 181 as a first recess portion is formed as recessing from an upstream end of the opposing duct portion 141 toward a downstream with respect to the conveying direction A and opens as a part of the surface of the conveying belt 7 can be seen from above. The penetrating portion 182 as a second recess portion is formed as recessing from the downstream end of the opposing duct portion 141 toward the upstream with respect to the conveying direction A and opens as a part of the surface of the conveying belt 7 can be seen from above. In the penetrating portions 181 and 182, their opening areas of the top side 121 are greater than the opening areas of the side of the warm air blowing surface 12, and a size of a cross-sectional area that crosses in the penetrating direction increases as the distance from the conveying belt 7 to the cross-sectional area increases.

### <Ribs>

Further, the blowing duct 14 is provided with a plurality of ribs 30, which project toward the conveying belt 7 from the warm air blowing surface 12 and are located at intervals of space in the width direction B as each rib being along with the conveying direction A, in the opposing duct portion 141. In the present embodiment, the ribs 30 are provided as connecting adjacent warm air blowing nozzles 10 each other, which are aligned in the conveying direction A. A projecting length of the ribs 30 from the warm air blowing surface 12 is preferred as same as the length from the warm air blowing surface 12 to the end of warm air blowing nozzles 10.

With the ribs 30, a part of the warm air blown by the warm air blowing nozzles 10 passes through easier from the penetrating portions 181 and 182 to above. In other words, the warm air blown from the warm air blowing nozzles 10 flows from a gap between the conveying belt 7 and the warm air blowing surface 12 as spreading along the warm air blowing surface 12 toward the conveying direction A, an opposite direction of the conveying direction, and the width direction B (refer in FIG. 5). And then, the part of warm air is guided through the gap between the conveying belt 7 and the warm air blowing surface 12 in a area, which is interposed with the pair of ribs 30 with respect to the width direction B, to the conveying direction A or to the opposite direction of the conveying direction A by the ribs 30. Therefore, much more warm air blows through the penetrating portions 181 and 182 from the warm air blowing surface 12 to the top side 121 before reaching the upstream end or the downstream end of the opposing duct portion 141, as compared with the case without the ribs 30.

Note that, though the ribs 30 are provided as connecting warm air blowing nozzles 10 each other in the present embodiment, it is not limited thereto. If the penetrating portions 181 and 182 are located in a position which is between the adjacent pair of ribs 30 (between the ribs) in the width direction B as seen from the conveying direction A, it is not necessary for the ribs 30 to be provided to connect the warm air blowing nozzles 10 each other. However, the ribs 30 are preferred to be provided to connect the warm air blowing nozzles 10 each other, because the warm air passes through easier from the warm air blowing surface 12 to the top side 121 in the penetrating portions 181 and 182. Also, as described above, when the length of projecting portion of the ribs 30 is preferred as same as the length from the warm air blowing surface 12 to the end of warm air blowing nozzles 10, because the warm air passes through easier from the warm air blowing surface 12 to the top side 121 in the penetrating portions 181 and 182.

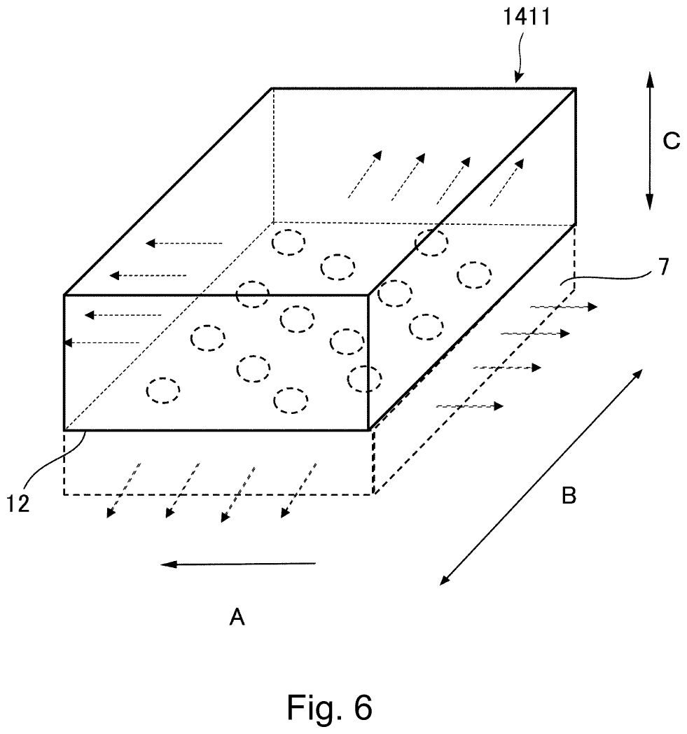

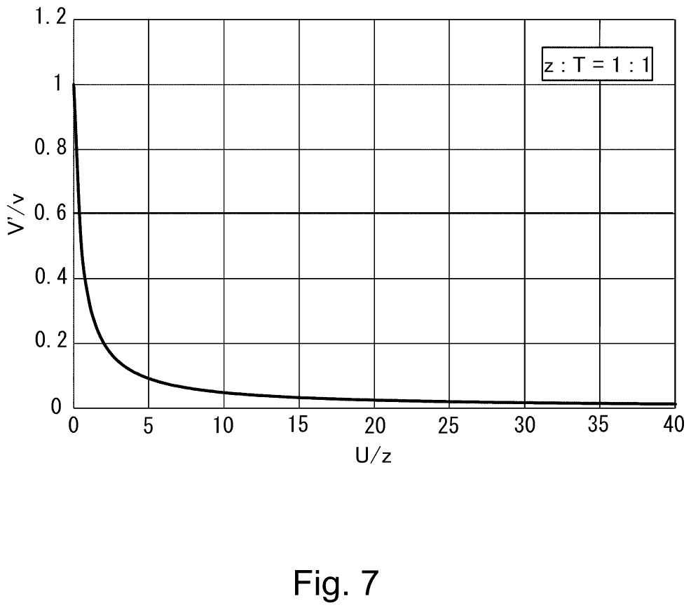

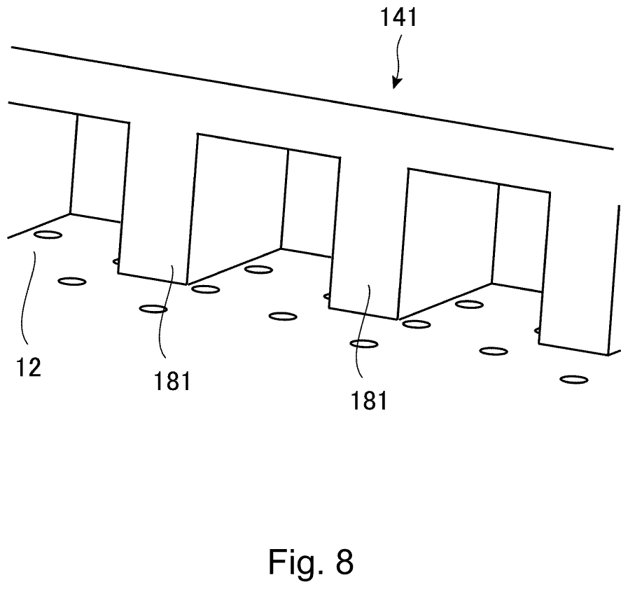

Next, relation between the warm air blown from the warm air blowing nozzles 10 and the warm air which blows through the gap between the conveying belt 7 and the warm air blowing surface 12 will be described with FIG. 6 to FIG. 8. FIG. 6 is a schematic view of the warm air flow in a case that there no penetrating portions for comparison. FIG. 7 is a graph showing relation between an air blowing speed ratio (V′/v) and a ratio (U/z) which is in between a total sum (U) of the opening areas on the side of the warm air blowing surface 12 of the penetrating portions 181 and 182 and a total area (z) of the blowing holes of the warm air blowing nozzles 10. FIG. 8 is a schematic view showing the penetrating portion 181 seen from inside of the opposing duct portion 141.

As FIG. 6 showing, with an opposing duct portion 1411 which is rectangular shape and does not include the penetrating portions 181 and 182, the warm air, which flows to the conveying direction A and the opposite direction of the conveying direction A among the warm air blown from the warm air blowing nozzles 10, blows through the gap between the conveying belt 7 and the warm air blowing surface 12 at both an upstream end and a downstream end of the opposing duct portion 1411. Also, the warm air, which flows to the width direction B among the warm air blown from the warm air blowing nozzles 10, blows through the gap between the conveying belt 7 and the warm air blowing surface 12 at both ends of the opposing duct portion 1411.

A total amount of the warm air blown from the warm air blowing nozzles 10 is assumed to be Q and a sum of a size of an opening area, which is in the gap between the conveying belt 7 and the warm air blowing surface 12 at the both the upstream end and the downstream end of the opposing duct portion 1411, and a sum of a size of an opening area, which is in the gap between the conveying belt 7 and the warm air blowing surface 12 at the both ends of a width direction of the opposing duct portion 1411, is assumed to be T. In this case, an average air blowing speed of the warm air which blows through the gap between the conveying belt 7 and the warm air blowing surface 12 is “V=Q/T”. Therefore, if a total air amount Q is constant, the average air blowing speed decreases as the sum T of opening area of the gap increases. In other words, in FIG. 3, when the distance H between the conveying belt 7 and the warm air blowing surface 12 is longer and the average the speed V of the warm air which blows through the gap between the conveying belt 7 and the warm air blowing surface 12 decreases, it suppresses that the sheet S floats off.

In the other hand, as described above, as the distance H between the warm air blowing surface 12 and the conveying belt 7 is the shorter, the faster the sheet S gets dried. Thus, in the present embodiment, the warm air blowing surface 12 is kept from getting too close to the conveying belt 7 by providing the warm air blowing nozzles 10 on the warm air blowing surface 12. Therefore, it is possible to dry the sheet S without excessively increasing the average air blowing speed V of the warm air that blows through the gap between the conveying belt 7 and the warm air blowing surface 12, as compared to the case that the warm air blowing surface 12 gets closer to the conveying belt 7 without providing with the warm air blowing nozzles 10.

Further, when the total sum of the opening areas on the side of the warm air blowing surface 12 of the penetrating portions 181 and 182 is assumed to be U, the average air blowing speed V′ of the warm air that blows through the gap between the conveying belt 7 and the warm air blowing surface 12 will be “V′=Q/(T+U)”. Since a part of the warm air blows through the penetrating portions 181 and 182, the average air blowing speed will be “V>V′”, in other words, “the average air blowing speed V which is the case without the penetrating portions 181 and 182>the average air blowing speed V′ which is the case with the penetrating portions 181 and 182. That is to say, the average air blowing speed of the warm air which blows through the gap between the conveying belt 7 and the warm air blowing surface 12 decreases when the penetrating portions 181 and 182 are provided, as compared with the case in which the penetrating portions 181 and 182 are provided. As described above, it is possible to decrease the warm air which blows through the gap between the conveying belt 7 and the warm air blowing surface 12 at the downstream end and the upstream end of the opposing duct portion 141 by providing the penetrating portions 181 and 182 in the present embodiment. Therefore, the sheet S can be suppressed to float off.

Note that, even if the penetrating portions 181 and 182 are formed as an elongated shape which is longer in a length of a width direction than in a length of a conveying direction, it is possible to decrease the warm air which blows through the gap between the conveying belt 7 and the warm air blowing surface 12 at the downstream end and the upstream end of the opposing duct portion 141. However, the penetrating portions 181 and 182 are preferred to be formed as an elongated shape which is longer in a length of a conveying direction than in a length of a width direction because the warm air can enter the penetrating portions 181 and 182 and the amount of the warm air which blows through from the warm air blowing surface 12 to the top side 121 increases.

Then, when the air blowing speed of the warm air blown from the warm air blowing nozzles 10 is represented as v and the total sum of the areas of the blowing holes is represented as z, it will be “v=Q/z”. Thus, if v and z are substituted to “V′=Q/(T+U)” as mentioned above, “V′=z/(T+U) v” is derived. Here, if “U=z” is substituted, it will be “V′=(1−T/(T+Z) v”. Due to the condition “1−T/(T+Z)<1”, “V′<v” will be derived.

Therefore, if the total sum U of the opening areas on the side of the warm air blowing surface 12 of the penetrating portions 181 and 182 is equal to or greater than the total area z of the blowing holes of the warm air blowing nozzles 10, it is possible that the average air blowing speed of the warm air which blows through the gap between the conveying belt 7 and the warm air blowing surface 12 is less than the air blowing speed of the warm air blown from the warm air blowing nozzles 10. Thus, the total sum U of the opening areas on the side of the warm air blowing surface 12 of the penetrating portions 181 and 182 is preferred to be equal to or greater than the total area z of the blowing holes of the warm air blowing nozzles 10.

As FIG. 7 showing, while the average air blowing speed V′ is going slower when the total sum U of the opening areas on the side of the warm air blowing surface 12 of the penetrating portions 181 and 182 is increasing, a decreasing rate of the average air blowing speed V′ is going low when the total sum U is increasing. In the case that “the total area z of the blowing holes of the warm air blowing nozzles 10: the sum T of the opening area of the gap=1:1”, the air blowing speed V′ decreases significantly in a range that the ratio “U/z” of which are the total sum U of the opening areas and the total area z of the blowing holes of the warm air blowing nozzles 10 is “1 to 10”. Therefore, the penetrating portions 181 and 182 are preferred to be formed as the total sum U of the opening areas on the side of the warm air blowing surface 12 of the penetrating portions 181 and 182 is about “1 to 10 times” of the total area z of the blowing holes of the warm air blowing nozzles 10.

As FIG. 8 showing, if the projecting length of the penetrating portions 181 and 182 is too long, molding failure may be occurred by a resin sticking to a metallic mold when the opposing duct portion 141 is injection-molded with the resin. Thus, with considered a degree of reducing effect of the air blowing speed by the penetrating portions 181 and 182 and suppressing component failure in manufacturing, a region 19 in which the penetrating portions 181 and 182 do not exist is formed as FIG. 4 showing by a broken line.

As described above, in the present embodiment, the opposing duct portion 141 is provided with the warm air blowing nozzles 10 and the ribs 30 on the warm air blowing surface 12. Also, the penetrating portions 181 and 182, which penetrate from the warm air blowing surface 12 to the top side 121, are formed in the upstream end and the downstream end of the opposing duct portion 141. It is possible to dry the sheet S effectively without the warm air blowing surface 12 being too close to the conveying belt 7 by providing the warm air blowing nozzles 10. A part of the warm air blown from the warm air blowing nozzles 10 flows to both the conveying direction A and the opposite direction of the conveying direction A and blows through the penetrating portions 181 and 182 from the warm air blowing surface 12 to the top side 121. The ribs 30 are provided as connecting the warm air blowing nozzles 10 each other in order the part of the warm air to blows through easier the penetrating portions 181 and 182. The part of the warm air blown from the warm air blowing nozzles 10 can flow easier through the gap between the conveying belt 7 and the warm air blowing surface 12 toward the side of the penetrating portions 181 and 182 by the ribs 30 and then blow through the penetrating portions 181 and 182 before reaching the upstream end or the downstream end of the opposing duct portion 141. Therefore, it is possible to decrease the warm air which blows through the gap between the conveying belt 7 and the warm air blowing surface 12 at the upstream end and the downstream end of the opposing duct portion 141. Thus, in the case that the sheet S is dried by blowing air (warm air) conveyed by the conveying belt 7, it is possible to improve drying the sheet S efficiently and to suppress the sheet S to float off the conveying belt 7.

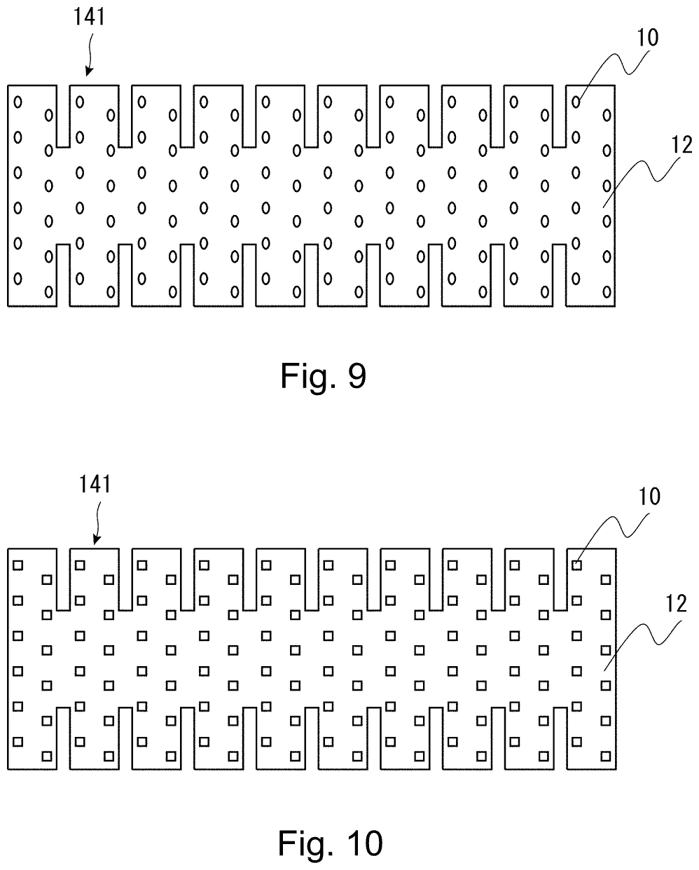

Note that, the warm air blowing nozzles 10 is limited to be formed in a circular column shape. Other shape examples of the warm air blowing nozzles 10 will be shown in FIG. 9 and FIG. 10. In FIG. 9 and FIG. 10, the ribs 30 described above is omitted to draw. As FIG. 9 showing, the warm air blowing nozzles 10 may be formed in an elliptic column shape of which a cross-section is an elliptic on the warm air blowing surface 12 of the opposing duct portion 141. Or the warm air blowing nozzles 10 may be formed in a quadrangular prism shape of which a cross-section is quadrangular on the warm air blowing surface 12 of the opposing duct portion 141 as well.

### Embodiment 2

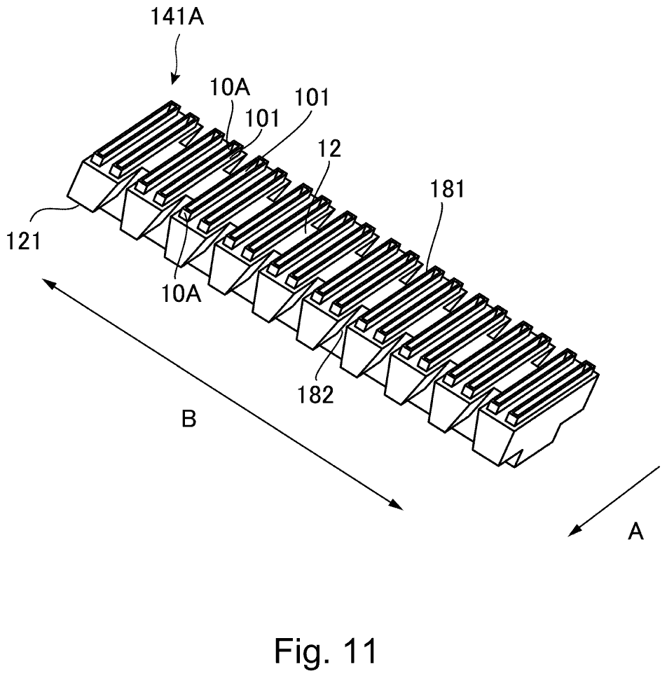

Next, an opposing duct portion 141A in an embodiment 2 will be described with FIG. 11. Note that, in the embodiment 2, same reference numerals are given to the same configuration of the opposing duct portion 141A as the opposing duct portion 141 in the embodiment 1 and the description are simplified or omitted.

As FIG. 11 showing, in the opposing duct portion 141A, one of warm air blowing nozzles 10A is formed as a slit shape of which the length of the conveying direction A is longer than the length of the width direction B and a plurality of the warm air blowing nozzles 10A are located at intervals of space in the width direction B. In the present embodiment, a blowing hole of a slit shape of which the length in the conveying direction is longer than the length in the width direction is formed at same intervals in the width direction B on the warm air blowing surface 12 of the opposing duct portion 141A and the warm air blowing nozzles 10A are provided to surround each blowing hole. As same as the embodiment 1, the warm air blowing nozzles 10A are provided as the length between the warm air blowing surface 12 and the end of the nozzle is, for example, “5 mm”. Then, the penetrating portions 181 and 182 are provided to be in a position between an adjacent pair of warm air blowing nozzles 10A (each other nozzles) in the width direction B when it is seen from the conveying direction A.

In the present embodiment, a side wall portion 101, which extends in the conveying direction A of the warm air blowing nozzles 10A, is functioning as same as the ribs 30 in the embodiment 1, and a part of the warm air blown from the warm air blowing nozzles 10A can blows easier through the penetrating portions 181 and 182 and above. In other words, the part of the warm air blown from the warm air blowing nozzles 10A in a region, where is interposed by the warm air blowing nozzles 10A with respect to the width direction B, flows along the different two of the side wall portions 101 which are facing each other as interposing the penetrating portions 181 and 182 of warm air blowing nozzles 10A toward the penetrating portions 181 and 182. Thus, the part of the warm air blows through the penetrating portions 181 and 182 from the warm air blowing surface 12 to the top side 121 before reaching an upstream end or a downstream end of the opposing duct portion 141A.

As described above, without the ribs 30, the part of the warm air blown from the warm air blowing nozzles 10A can flow through the gap between the conveying belt 7 and the warm air blowing surface 12 easier to the side of the penetrating portions 181 and 182 by the side wall portion 101 of the warm air blowing nozzles 10A. Therefore, the part of the warm air blows through the penetrating portions 181 and 182 before reaching the upstream end or the downstream end of the opposing duct portion 141A. Thus, the same effect is obtained as described above in the embodiment 1, which is that in the case the sheet S is dried by blowing air (warm air) conveyed by the conveying belt 7, it is possible to improve drying the sheet S efficiently and to suppress the sheet S to float off the conveying belt 7. Note that, a plurality of the blowing holes may be formed in the conveying direction A on each row of the warm air blowing nozzles 10A on the width direction B. In this case, the warm air blowing nozzles 10A is at least required to be provided as surrounding a plurality of the blowing holes aligned in the conveying direction A.

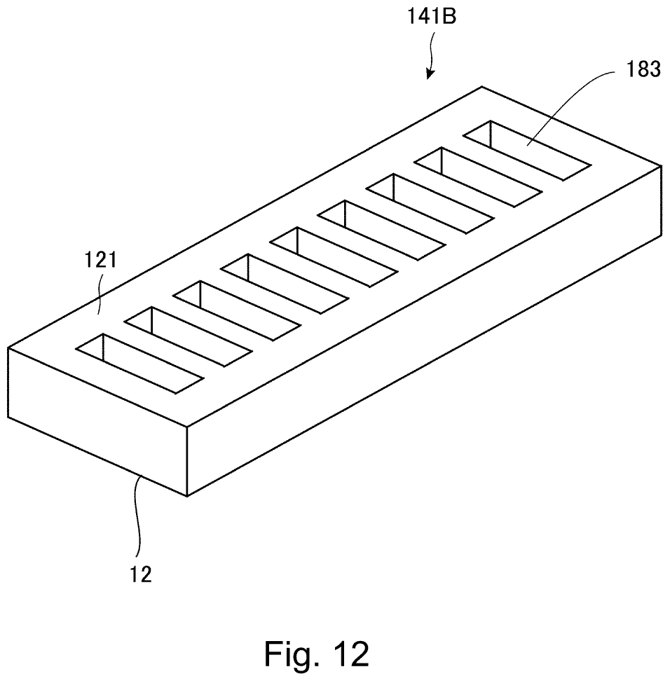

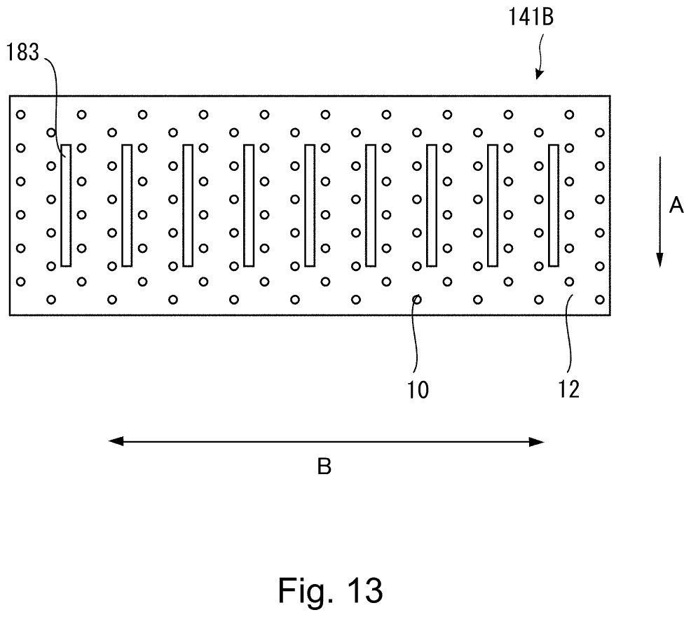

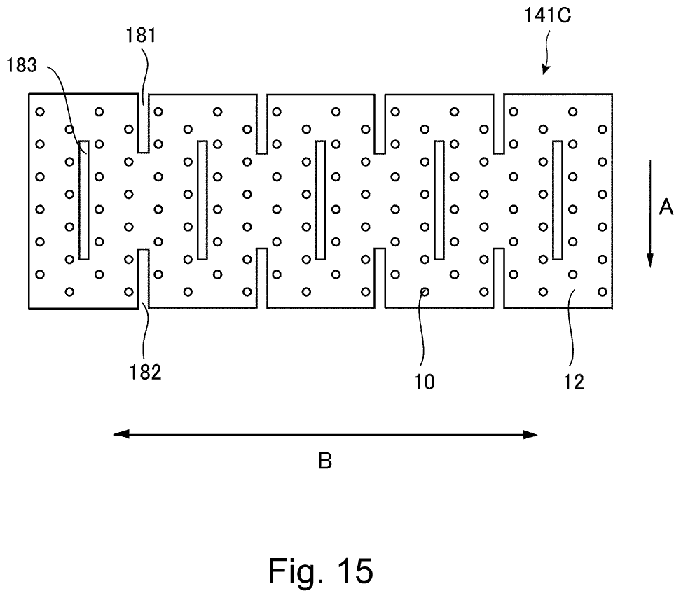

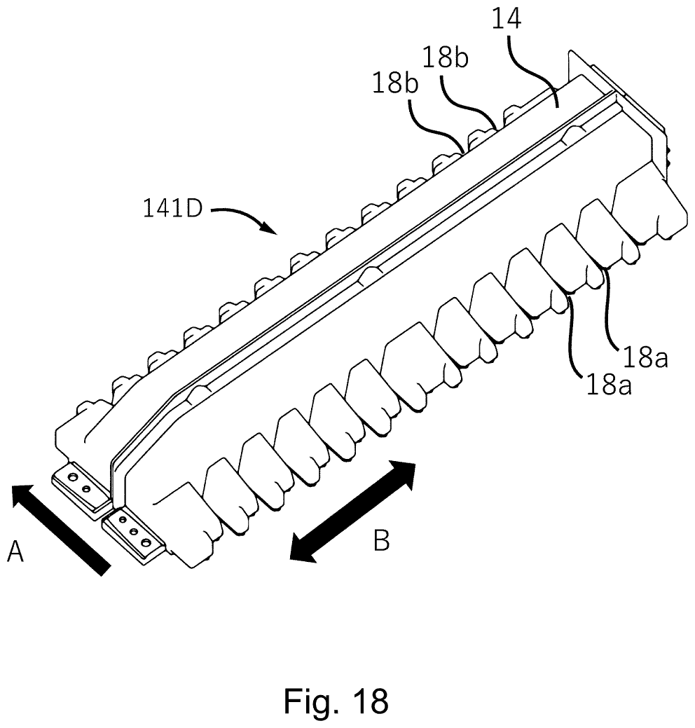

Note that, the examples of the penetrating portions in the embodiment 1 and 2 described above are not limited to the penetrating portion 181 which is formed as recessing from the upstream end toward the downstream of the opposing duct portion 141 and the penetrating portion 182 which is formed as recessing from the downstream end toward the upstream of the opposing duct portion 141 (refer in FIG. 4 and FIG. 11). Other embodiments with the opposing duct portions with the different shape penetrating portions will be shown in FIGS. 12 to 18. Here, the same numeral references are given to same configurations as the opposing duct portions 141 or 141A, and descriptions will be simplified or omitted. Note that, the ribs 30 described above is omitted to show in FIGS. 13 and 15 to understand descriptions easier.

### Embodiment 3

Next, an opposing duct portion 141B in an embodiment 3 will be described with FIGS. 12 and 13. As FIGS. 12 and 13 showing, in the opposing duct portion 141B, a penetrating portion 183 is formed as a through hole which is formed in a center portion of the conveying direction A and is not opening to an upstream end or to a downstream end. The penetrating portion 183 is formed as an elongate shape of which a length in the conveying direction is longer than a length in the width direction, and is located in a position between the adjacent pair of the warm air blowing nozzles 10 which are aligned in the width direction B seen from the conveying direction A. A part of the warm air blown from the warm air blowing nozzles 10 blows from the warm air blowing surface 12 to the top side 121 in the penetrating portion 183. Therefore, the warm air that blows through the gap between the conveying belt 7 and the warm air blowing surface 12 can be decreased in the upstream end or the downstream end of the opposing duct portion 141B.

### Embodiment 4

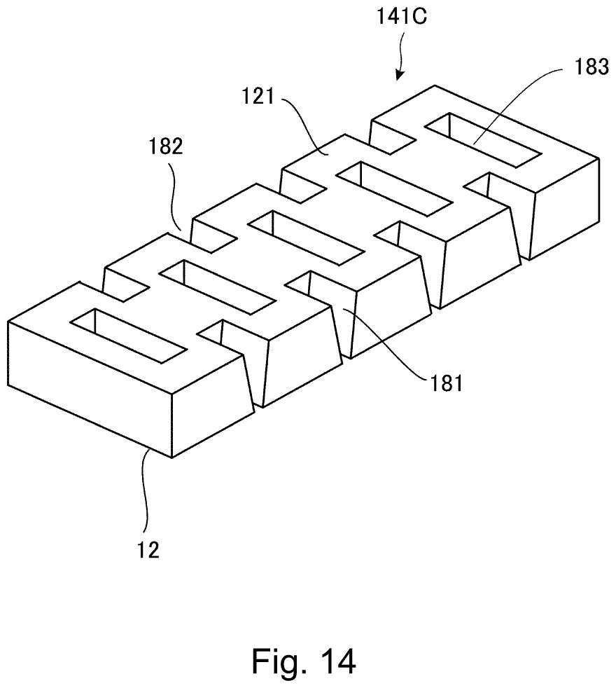

Next, an opposing duct portion 141C in an embodiment 4 will be described with FIGS. 14 and 15. As FIGS. 14 and 15 showing, both the penetrating portions 181, 182 (refer in FIG. 4) and the penetrating portion 183 (refer in FIG. 12) described above are formed in the opposing duct portion 141C. A part of the warm air blown from the warm air blowing nozzles 10 blows through the penetrating portions 181, 182, and 183 from the warm air blowing surface 12 to the top side 121. Therefore, the warm air that blows through the gap between the conveying belt 7 and the warm air blowing surface 12 can be decreased in the upstream end or the downstream end of the opposing duct portion 141C.

### Embodiment 5

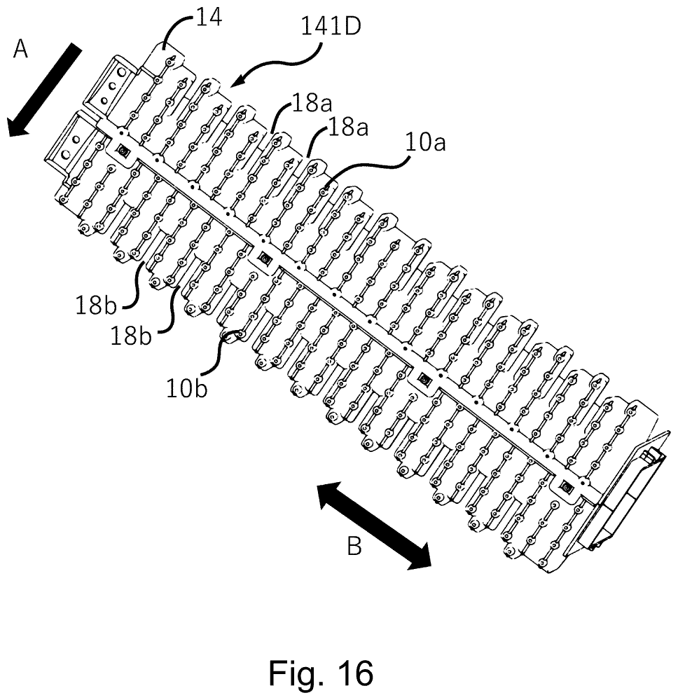

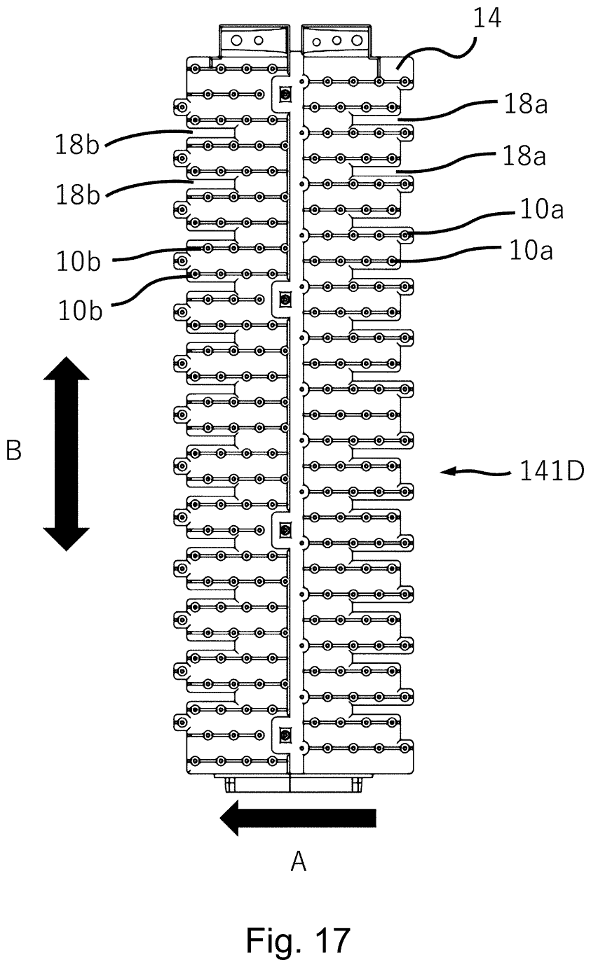

Next, an opposing duct portion 141D will be described with FIG. 16 to FIG. 18. As FIGS. 16 and 17 showing, a plurality of upstream nozzles 10a which blow warm air onto the sheet S are provided in the upstream side of the conveying direction A and a plurality of downstream nozzles 10b which blow warm air onto the sheet S are provided in the downstream side of the conveying direction A in the opposing duct portion 141D. Both the upstream nozzles 10a and the downstream nozzles 10b are located at intervals of space in the width direction B and each of them is aligned along the conveying direction A.

As FIGS. 16 to 18 showing, an upstream penetrating portion 18a is provided in the upstream side in the conveying direction A and a downstream penetrating portion 18b is provided in the downstream side in the conveying direction A in the opposing duct portion 141D. Each upstream penetrating portion 18a and the downstream penetrating portion 18b is formed as an elongate shape, of which a length of the conveying direction is longer than a length of the width direction along the conveying direction A, on both ends of the opposing duct portion 141D with respect to the conveying direction A.

A strength of warm air that the sheet S receives by the warm air blowing nozzles 10 is determined by a position of the warm air blowing nozzles 10 in the width direction B. In the opposing duct portions described above in the embodiment 1 to the embodiment 4, the warm air blowing nozzles are aligned at intervals of space in the width direction B on the same position. In these cases, the warm air strength that the sheet S receives by the warm air blowing nozzles 10 tends to generate intensity changes and unevenness of drying might occur in the one side of the sheet S. In view of this concern, the upstream nozzles 10a provided in the upstream in the conveying direction A and the downstream nozzles 10b provided in the downstream are aligned as deviating each other in the width direction B in the opposing duct portion 141D in the embodiment 5. Thus, the warm air strength that the sheet S receives by the upstream nozzles 10a and the downstream nozzles 10b become to hardly generate intensity changes in the one side of the sheet S and can suppress to occur unevenness of drying.

Also, since the upstream nozzles 10a and downstream nozzles 10b are aligned as deviating in the width direction B as described above, the upstream penetrating portion 18a and the downstream penetrating portion 18b are aligned as deviating each other in the width direction B in the opposing duct portion 141D. By that the upstream penetrating portion 18a and the downstream penetrating portion 18b are aligned as deviating in the width direction B, the warm air which the upstream nozzles 10a or the downstream nozzles 10b blow onto the sheet S can go out easier between the conveying belt 7 and the blowing duct 14.

Note that, though the blowing unit 8 in the warm air blowing unit 3400 was described as the example in the embodiments described above, it is not limited to this. The embodiments described above may apply to the blowing unit 3201 (refer to FIG. 1) to blow air onto the sheet S in the decoupling portion 3200, for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2023-085248 filed on May 24, 2023 and 2023-173857 filed on Oct. 5, 2023, which are hereby incorporated by reference herein in their entirety.

What is claimed is:

1. A drying device for drying a sheet on which an image is formed by discharged ink, the drying device comprising:
a conveyance means configured to convey the sheet;
a blowing fan;
a duct configured to guide an air blown from the blowing fan to the sheet conveyed by the conveyance means; and
a heating means configured to heat the air in the duct,
wherein the duct includes:
a plurality of nozzles configured to blow the air in the duct to the sheet conveyed by the conveyance means;
a first surface provided with the plurality of nozzles;
a second surface opposing the first surface; and
at least one recess portion formed along a conveyance direction of the sheet,
wherein in a widthwise direction perpendicular to the conveyance direction, the recess portion is provided between a first nozzle and a second nozzle, of the plurality of nozzles, the second nozzle being disposed side by side with the first nozzle.

2. A drying device according to claim 1, wherein the at least one recess portion is a plurality of recess portions, the plurality of recess portions are provided in the widthwise direction.

3. A drying device according to claim 1, further comprising at least one rib projected toward the conveyance means from the first surface and formed along the conveyance direction.

4. A drying device according to claim 3, wherein the at least one rib is a plurality of ribs, the plurality of ribs are provided in the widthwise direction.

5. A drying device according to claim 4, wherein the ribs are provided so as to connect the adjacent nozzles in the conveyance direction.

6. A drying device according to claim 5, wherein an amount of projection of the ribs from the first surface is equal to an amount of projection of the nozzles from the first surface.

7. A drying device according to claim 1, wherein the at least one recess portion is not formed in a center of the duct in the conveyance direction.

8. A drying device according to claim 7, the at least one recess portion is provided upstream and downstream, respectively, with respect to the center of the duct in the conveyance direction.

9. A drying device according to claim 8, wherein the at least one recess portion includes
an upstream recess portion provided upstream with respect to the center of the duct in the conveyance direction, the upstream recess portion being continuously provided up to an upstream end of the duct in the conveyance direction, and
a downstream recess portion provided downstream with respect to the center of the duct in the conveyance direction, the downstream recess portion being continuously provided up to a downstream end of the duct in the conveyance direction.

10. A drying device according to claim 1, wherein the duct is provided above the conveyance means in a vertical direction, and
wherein the air discharged from the nozzles and passing through the at least one recess portion upward from below in the vertical direction is blown to inside the duct again by the blowing fan.
